(19) United States
(12) Patent Application Publication
(10) Pub. No.: US 2014/0122609 A1
(43) Pub. Date: May 1, 2014

(54) SERVICE PROVIDING APPARATUS, SERVICE PROVIDING METHOD, AND STORAGE MEDIUM

(71) Applicant: Kazuhiro Sakata, Tokyo (JP)

(72) Inventor: Kazuhiro Sakata, Tokyo (JP)

(73) Assignee: NEC CORPORATION, Minato-ku, Tokyo (JP)

(21) Appl. No.: 14/128,963

(22) PCT Filed: Jun. 29, 2012
(86) PCT No.: PCT/JP2012/067249

§ 371 Date: Dec. 23, 2013

(30) Foreign Application Priority Data
Jul. 8, 2011 (JP) 2011-151589

(51) Int. Cl. H04L 29/08

(52) U.S. Cl. CPC H04L 67/306
USPC 709/204

(57) ABSTRACT

In a service providing system which provides communication among a plurality of users, an acquaintance is registered as a communication target user without using text-based information about the acquaintance. A user information storage unit (111) stores user information (121) which includes image data of each of the plurality of users. A user extraction unit (104) extracts, when image data which is indicated from a terminal of a first user among the plurality of users is inputted, a user having image data which is similar to the inputted image data in the user information (112) as a registration user candidate who is a candidate of a user registered as a communication target by the first user, from the plurality of users, and outputs the extracted user to the terminal of the first user.

### TECHNICAL FIELD

The present invention relates to a service providing apparatus, a service providing method, and a service providing program for providing communication among users.

### BACKGROUND ART

In recent years, utilization of social networking service (hereinafter, SNS) that is a service in which a social network of persons is established on the Internet becomes common. In the SNS, the user registers an acquaintance or the like and various communications among the registered users are supported. Facebook (registered trademark), mixi (registered trademark), and the like are known as typical SNS services.

In the SNS, when the user registers a communication target user, first, the user has to search for a person such as the acquaintance or the like with which the user wants to communicate, among the SNS users. As a method for searching for a person, there is a method which searches for a person by using text-based information of the person such as name, mail address, living area, affiliation, interest, age, or the like as a key. The user inputs the information about the communication target person in the SNS system and the SNS system sends a list of users that are searched for based on the key to the user. The user selects a user to be registered as the communication target person from the list.

For example, in non-patent literature 1, it is described that the search is performed by using a name or a mail address of an acquaintance as a key word and the acquaintance is selected from the SNS users.

### CITATION LIST

### Non-Patent Literature

[Non-patent literature 1]

http://www.facebook-japan.com/use/part2/retrieval.html

### SUMMARY OF INVENTION

### Technical Problem

However, in the SNS system described in the above-mentioned non-patent literature 1, when a user registers an acquaintance as a communication target user, the user has to know the above-mentioned text-based information about the acquaintance such as the name and the mail address of the acquaintance.

An object of the present invention is to provide a service providing system, a service providing method, and a service providing program which can solve the above-mentioned problem and register an acquaintance as a communication target user without using text-based information about the acquaintance in the service providing system which provides communication among a plurality of users.

### Solution to Problem

A service providing apparatus according to an exemplary aspect of the invention includes: a user information storage means for storing user information which includes image data of each of a plurality of users; and a user extraction means for extracting, when image data which is indicated from a terminal of a first user among the plurality of users is inputted, a user having image data which is similar to the inputted image data in the user information as a registration user candidate who is a candidate of a user registered as a communication target by the first user, from the plurality of users, and outputting the extracted user to the terminal of the first user.

A service providing method according to an exemplary aspect of the invention includes: storing user information which includes image data of each of a plurality of users; and extracting, when image data which is indicated from a terminal of a first user among the plurality of users is inputted, a user having image data which is similar to the inputted image data in the user information as a registration user candidate who is a candidate of a user registered as a communication target by the first user, from the plurality of users, and outputting the extracted user to the terminal of the first user.

A computer readable storage medium according to an exemplary aspect of the invention, records thereon a program, causing a computer to perform a method including: storing user information which includes image data of each of a plurality of users; and extracting, when image data which is indicated from a terminal of a first user among the plurality of users is inputted, a user having image data which is similar to the inputted image data in the user information as a registration user candidate who is a candidate of a user registered as a communication target by the first user, from the plurality of users, and outputting the extracted user to the terminal of the first user.

### Advantageous Effect of Invention

The effect of the present invention is to be able to register an acquaintance as a communication target user without using the text-based information about the acquaintance in the service providing system which provides communication among a plurality of users.

### BRIEF DESCRIPTION OF THE DRAWINGS

FIG. 1 is a block diagram showing a characteristic configuration according to a first exemplary embodiment of the present invention.

FIG. 2 is a block diagram showing a configuration of a service providing system 1 according to the first exemplary embodiment of the present invention.

FIG. 3 is a flowchart showing a process of a service providing apparatus 100 according to the first exemplary embodiment of the present invention.

FIG. 4 is a figure showing an example of user information 121 according to the first exemplary embodiment of the present invention.

FIG. 5 is a figure showing an example of image data registered as a profile image according to the first exemplary embodiment of the present invention.

FIG. 6 is a figure showing an example of a user interface for image input according to the first exemplary embodiment of the present invention.

FIG. 7 is a figure showing an example of image data inputted from a requesting user according to the first exemplary embodiment of the present invention.

FIG. 8 is an example of a friend candidate list 122 according to the first exemplary embodiment of the present invention.

FIG. 9 is a figure showing an example of a user interface for friend candidate output according to the first exemplary embodiment of the present invention.

FIG. 10 is an example of a friend candidate list 122 according to a second exemplary embodiment of the present invention.

FIG. 11 is an example of a user interface for friend candidate output according to the second exemplary embodiment of the present invention.

FIG. 12 is a flowchart showing a process of a service providing apparatus 100 according to a third exemplary embodiment of the present invention.

FIG. 13 is a figure showing an example of image data inputted from a requesting user according to the third exemplary embodiment of the present invention.

### DESCRIPTION OF EMBODIMENTS

### First Exemplary Embodiment

Next, a first exemplary embodiment of the present invention will be described.

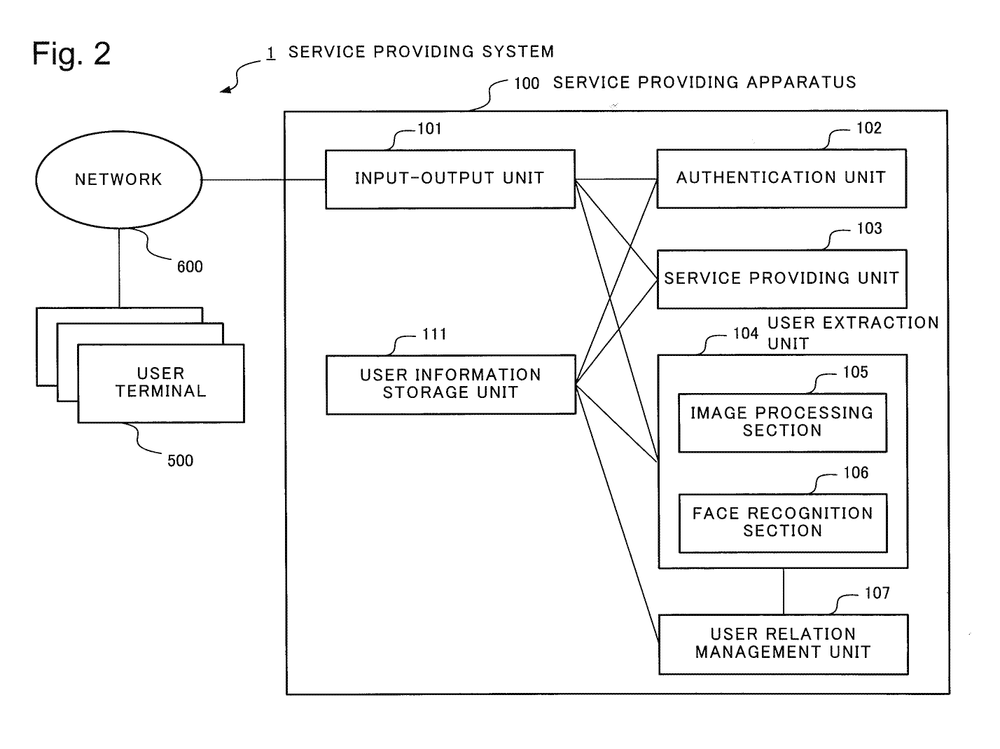

First, a configuration of the first exemplary embodiment of the present invention will be described. FIG. 2 is a block diagram showing a configuration of a service providing system 1 according to the first exemplary embodiment of the present invention.

Referring to FIG. 2, the service providing system 1 according to the first exemplary embodiment of the present invention includes a service providing apparatus 100 and a plurality of user terminals 500.

The service providing apparatus 100 is connected to the user terminal 500 via a network 600 such as a wireless public network, the Internet.

The service providing apparatus 100 provides a communication service between each user and another user registered by the each user as a “friend” among a plurality of users, like SNS, for example. Here, the communication includes a message exchange by mail or chat and a provision of content such as a diary, a photograph, between the each user and another user registered as the friend. The user terminal 500 is a terminal such as a personal computer, a portable phone, a smart phone that is used by the user for the service.

The service providing apparatus 100 includes an input-output unit 101, an authentication unit 102, a service providing unit 103, a user extraction unit 104, a user relation management unit 107, and a user information storage unit 111.

Here, the input-output unit 101 communicates with the user terminal 500.

The authentication unit 102 determines whether or not a user is a permitted user to which a service can be provided.

The service providing unit 103 controls the provision of service mentioned above to the user.

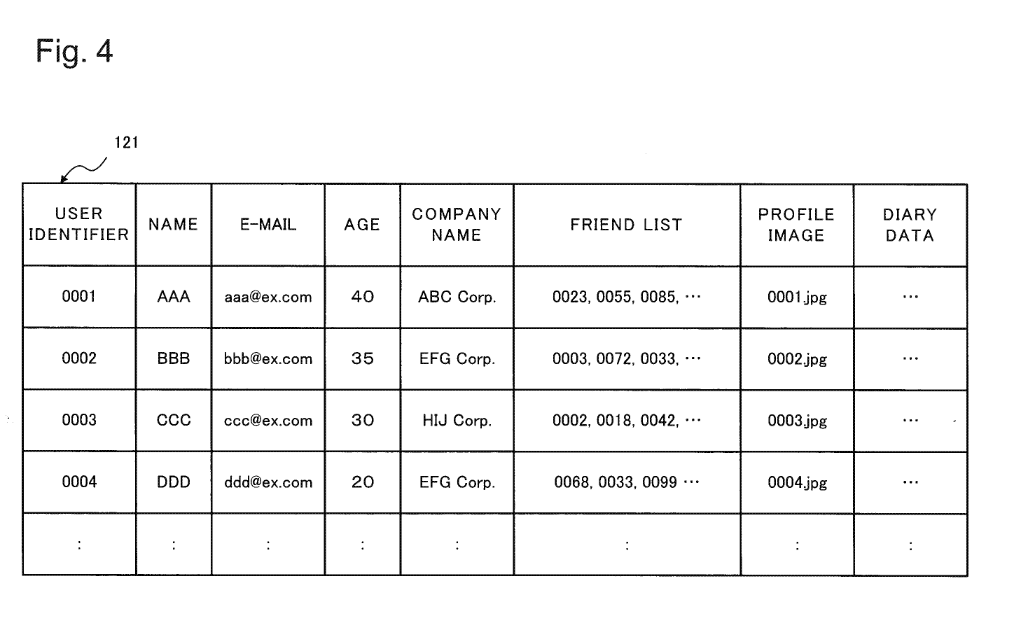

The user information storage unit 111 stores user information 121. FIG. 4 is a figure showing an example of the user information 121 according to the first exemplary embodiment of the present invention.

The user information 121 includes, for each of the plurality of users, a user identifier, a name, an e-mail address, an age, a company name, a friend list, a profile image, and diary data of the user.

Here, the friend list is a list (a registered user list) of the user identifiers of the other users (registered users) that are registered by the user as the friend.

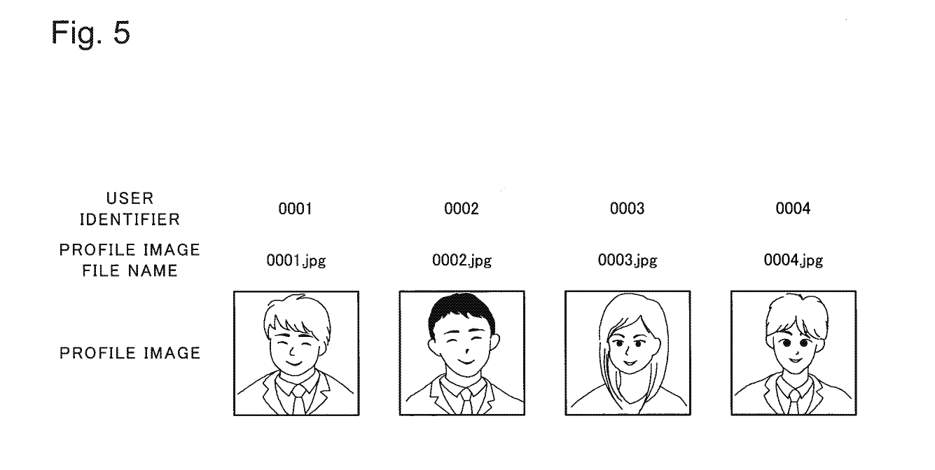

The profile image is a file name of image data such as a photograph of the user that is registered by the user. FIG. 5 is a figure showing an example of the image data registered as the profile image according to the first exemplary embodiment of the present invention. As shown in FIG. 5, the image data of the profile image includes a face image of each user. These pieces of image data are stored in the user information storage unit 111, together with the user information 121.

Note that, the content of the above-mentioned user information 121 and the storage method are shown as an example and another content and another storage method may be used if the another content and the another storage method can be utilized by the service providing apparatus 100.

The user extraction unit 104 receives, from a user (hereinafter, a requesting user or a first user) who requests registration of a certain person (a target person) such as an acquaintance as a friend in the service providing system, the image data such as a photograph including a face image of the target person. The user extraction unit 104 extracts a user whose face image is similar to that of the target person from the plurality of users, as a friend candidate (a registration user candidate).

The user extraction unit 104 includes an image processing section 105 and a face recognition section 106. The image processing section 105 extracts the friend candidate from the plurality of users based on a degree of similarity between face image data of the target person and face image data of each user among the plurality of users. The face recognition section 106 extracts the face image data from the image data. Further, the face recognition section 106 calculates the degree of similarity between two pieces of face image data based on the feature quantity of the two pieces of face image data.

Note that, the face recognition section 106 can use any technology if it can extract the face image data of a person from the image data and calculate the degree of similarity between pieces of the face image data. For example, the face recognition section 106 may perform the extraction of the face image data and the calculation of the degree of similarity by using a technology described in NEC technical report, Vol. 63, No. 3 (2010), pp. 26 to 30.

The user relation management unit 107 registers a user in the friend list in the user information 121.

Each user accesses the service providing apparatus 100 via the user terminal 500. When the user is authenticated by the authentication unit 102, the user uses various services (a message exchange with another user registered in the friend list, referencing or updating of contents of the user, referencing of contents of another user registered in the friend list, and the like) provided by the service providing unit 103.

Note that, the service providing apparatus 100 may be a computer which includes a CPU (Central Processing Unit) and a storage medium storing a program and operates according to a control based on the program.

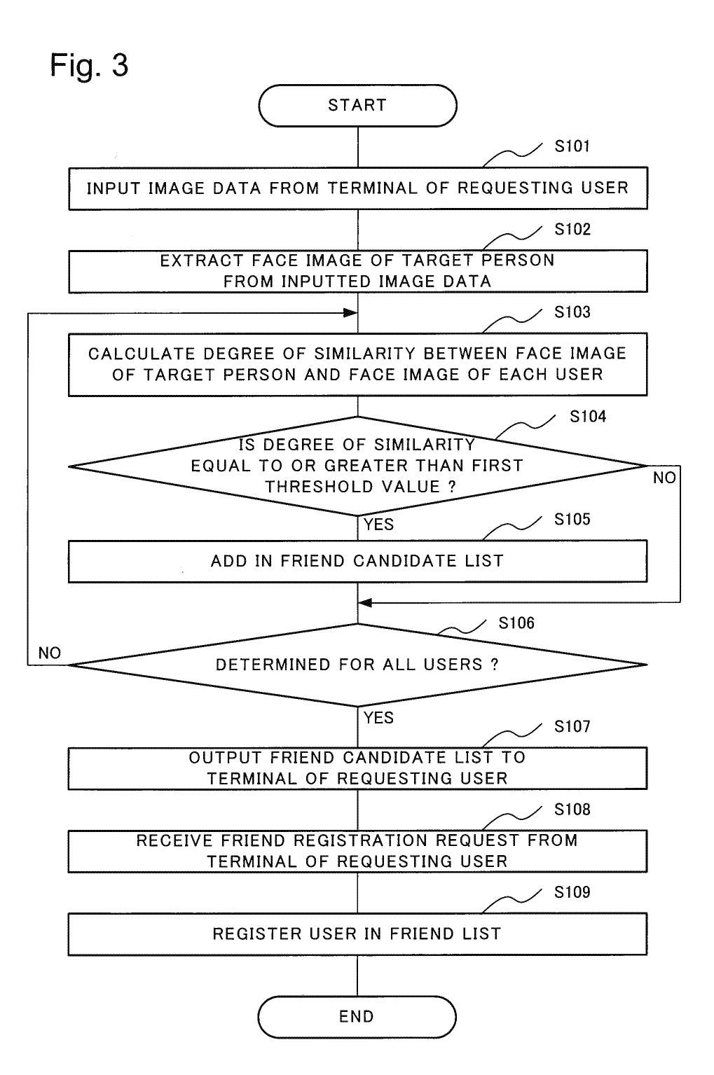

Next, operation of the service providing apparatus 100 according to the first exemplary embodiment of the present invention will be described. FIG. 3 is a flowchart showing a process of the service providing apparatus 100 according to the first exemplary embodiment of the present invention.

Here, the operation of the service providing apparatus 100 will be described by taking a case in which the user information 121 shown in FIG.

4 and the profile image shown in FIG. 5 are stored in the user information storage unit 111 and a user having the user identifier of “0004” that is the requesting user registers an acquaintance as a friend as an example.

First, the user extraction unit 104 of the service providing apparatus 100 receives input of image data including face image of the target person (acquaintance) from the user terminal 500 of the requesting user (step S101). Here, the user terminal 500 of the requesting user is the user terminal 500 associated with the requesting user by the authentication process or the like performed by the authentication unit 102.

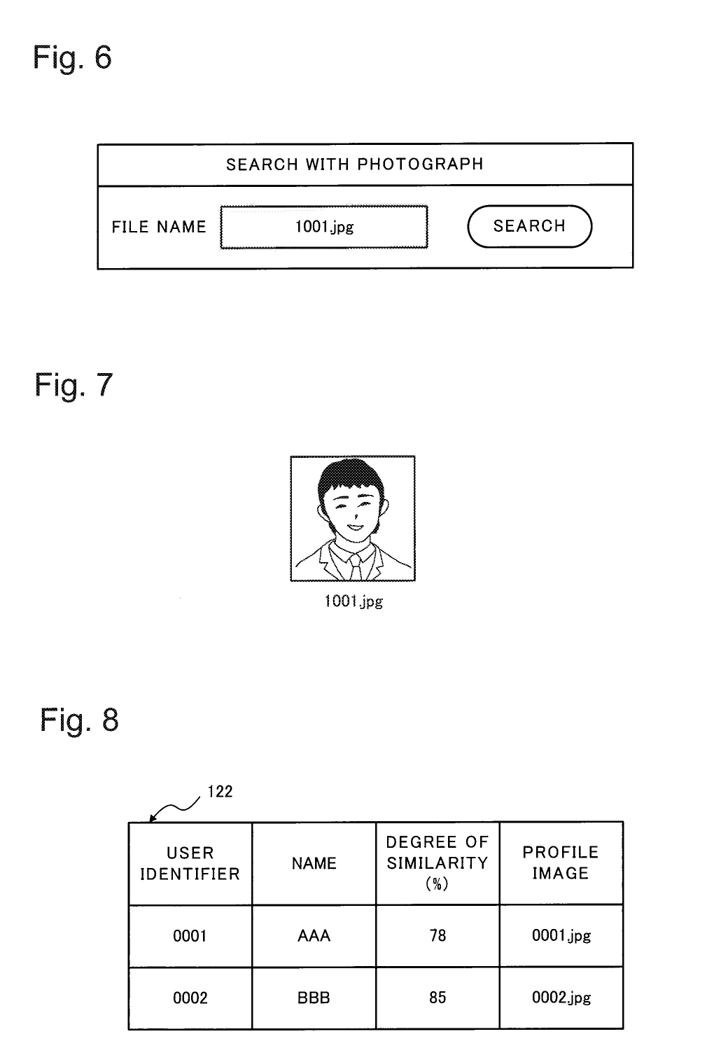

FIG. 6 is a figure showing an example of a user interface for the image input according to the first exemplary embodiment of the present invention.

For example, the user extraction unit 104 transmits the user interface shown in FIG. 6 to the user terminal 500 of the requesting user. The user terminal 500 acquires the image data from the requesting user by using the user interface shown in FIG. 6. The user terminal 500 transmits the image data to the user extraction unit 104 of the service providing apparatus 100 and instructs the user extraction unit 104 of receiving input of the image data.

Note that, the user interface shown in FIG. 6 is shown as an example. Therefore, another method may be used if the user terminal 500 can acquire the image data. For example, the user terminal 500 of the requesting user may activate a camera included in the user terminal 500 and transmit the image data generated by the camera to the service providing apparatus 100.

Further, the user terminal 500 of the requesting user may instruct the service providing apparatus 100 of acquisition of the image data stored in a storage apparatus (not shown) connected to the network 600 and the service providing apparatus 100 may acquire the requested image data from the storage device.

FIG. 7 is a figure showing an example of the image data inputted from the requesting user according to the first exemplary embodiment of the present invention. Here, face image of the user having the user identifier of “0002” that is the target person (acquaintance) is included in the image data shown in FIG. 7.

For example, the user extraction unit 104 receives input of the image data shown in FIG. 7 from the user terminal 500 of the user having the user identifier of “0004”.

Next, the image processing section 105 of the user extraction unit 104 extracts face image data (face image data of the target person) from the image data inputted in step S101 by using the face recognition section 106 (step S102).

The image processing section 105 calculates a degree of similarity between the face image data of the target person and the face image data included in the profile image of the user information 121 for each user other than the requesting user (step S103). Here, the image processing section 105 calculates the degree of similarity by extracting the face image data from the image data of the profile image of each user by using the face recognition section 106 and comparing it with the face image data of the target person.

The image processing section 105 determines whether or not the value of the degree of similarity calculated in step S103 is equal to or greater than a predetermined threshold value (a first threshold value) (step S104). When the degree of similarity is equal to or greater than the predetermined threshold value (first threshold value) (step S104/Yes), the image processing section 105 adds the user identifier of the user in a friend candidate list 122 (registration user candidate list) that is a list of the friend candidates (step S105).

The image processing section 105 repeats the processes of steps S103 to S105 to all the users other than the requesting user (step S106).

Note that, the image processing section 105 may add for example, the calculated degree of similarity, the name of the user, the file name of the image data of the profile image of the user, and the like, in the friend candidate list 122, as information related to the user, together with the user identifier of the user.

FIG. 8 is an example of the friend candidate list 122 according to the first exemplary embodiment of the present invention. For example, the image processing section 105 compares the face image data extracted from the image data shown in FIG. 7 with the face image data extracted from the image data of each profile image shown in FIG. 5 and generates the friend candidate list 122 as shown in FIG. 8. In the example shown in FIG. 8, the user identifier of “0001” and the user identifier of “0002”, for which the degree of similarity is equal to or greater than the predetermined threshold value (the first threshold value), are set in the friend candidate list 122.

Note that, in step S103, when a plurality of profile images exist for a certain user, the image processing section 105 may calculate the degree of similarity for the face image data extracted from each of the plurality of profile images and calculate one degree of similarity based on the calculated plurality of degrees of similarity. Similarly, when a plurality of pieces of face image data are extracted from one profile image, the image processing section 105 may calculate the degree of similarity for each of the plurality of pieces of face image data and calculate one degree of similarity based on the calculated plurality of degrees of similarity. In this case, for example, an average value of the plurality of degrees of similarity or a maximum value of the plurality of degrees of similarity may be used as the degree of similarity for the user.

Further, in step S102, when pieces of face image data of a plurality of target persons are extracted from the image data inputted from the requesting user, the image processing section 105 may repeat the processes of steps S103 to S106 for each target person.

Next, the image processing section 105 outputs the content of the friend candidate list 122 to the user terminal 500 of the requesting user (step S107). The user terminal 500 outputs the content of the friend candidate list 122 to the requesting user.

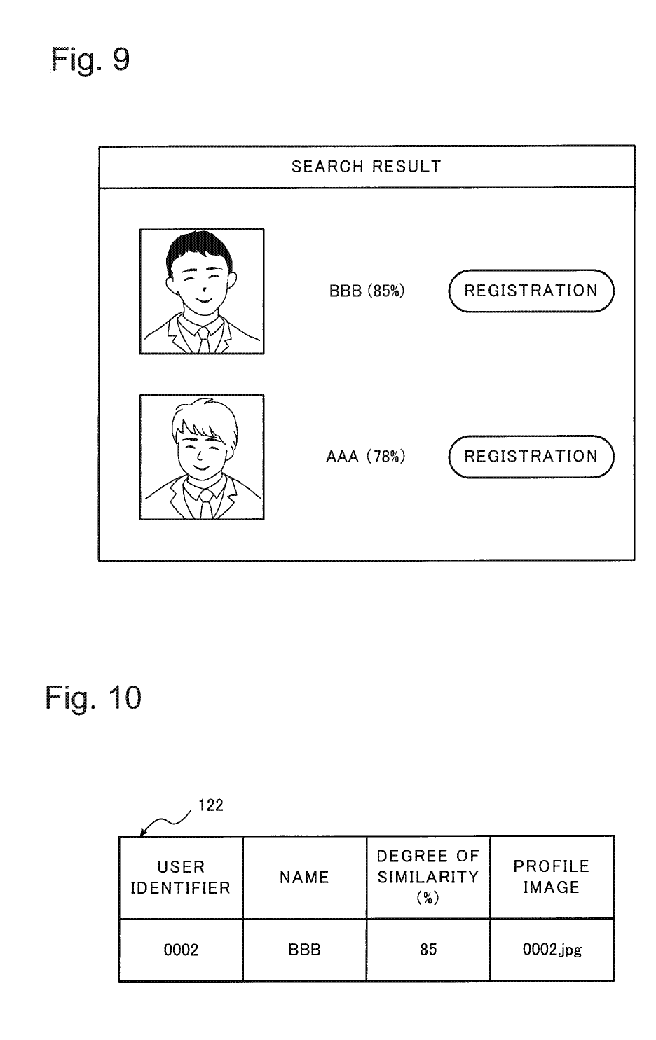

FIG. 9 is a figure showing an example of a user interface for friend candidate output according to the first exemplary embodiment of the present invention. Here, the image processing section 105 generates the user interface shown in FIG. 9, for example, based on the friend candidate list 122 shown in FIG. 8 and outputs the generated user interface to the user terminal 500 of the requesting user. The user terminal 500 displays the user interface shown in FIG. 9 to the requesting user.

In the example shown in FIG. 9, the user interface shows the profile image, the name, and the degree of similarity of each of the users included in the friend candidate list 122 in descending order of the degree of similarity. Further, a registration button by which the requesting user can designate the user shown in the user interface and request a friend registration of the designated user is also displayed.

Note that, the user interface shown in FIG. 9 is shown as an example. The user terminal 500 may use another user interface if the content of the friend candidate list 122 can be displayed to the requesting user and the request of the friend registration can be acquired.

When the requesting user finds the target person (acquaintance) in the users outputted by the user terminal 500, the requesting user designates the user and requests the friend registration.

The user terminal 500 transmits a friend registration request including the user identifier of the user of which the friend registration is requested to the service providing apparatus 100.

For example, when the requesting user recognizes the user having the user identifier of “0002” as the target person (acquaintance) and requests the friend registration of the user, the user terminal 500 transmits the friend registration request including the user identifier of “0002”.

The image processing section 105 of the service providing apparatus 100 receives the friend registration request from the user terminal 500 of the requesting user (step S108). The image processing section 105 registers the user identifier of the user of which the friend registration is requested in the friend list of the requesting user in the user information 121, through the user relation management unit 107 (step S109).

For example, the image processing section 105 adds the user identifier of “0002” in the friend list of the user having the user identifier of “0004” in the user information 121 shown in FIG. 4.

Note that, when the image processing section 105 registers the user in the friend list, the image processing section 105 may add for example, information indicating that the user is extracted based on the image, information related to the image data of the target person used for the extraction, and the like, as information related to the user, together with the user identifier of the user.

When the user relation management unit 107 registers the user in the friend list, the user relation management unit 107 may confirm whether or not the user allows the friend registration requested by the requesting user and register the user in the friend list of the requesting user when it is allowed. In this case, the user relation management unit 107 may register the requesting user in the friend list of the user.

With that, the operation according to the first exemplary embodiment of the present invention is completed.

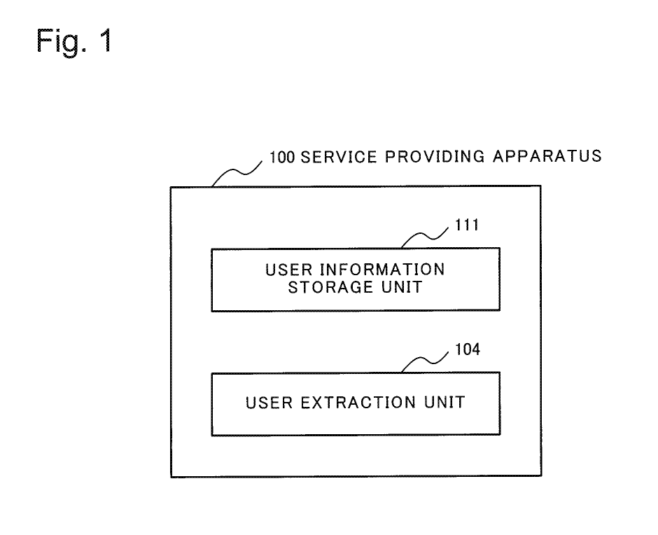

Next, a characteristic configuration of the first exemplary embodiment of the present invention will be described. FIG. 1 is a block diagram showing a characteristic configuration according to the first exemplary embodiment of the present invention.

A service providing apparatus 100 provides communication among registered users out of a plurality of users. Referring to FIG. 1, the service providing apparatus 100 includes a user information storage unit 111 and a user extraction unit 104.

The user information storage unit 111 stores user information 121 which includes image data of each of the plurality of users. The user extraction unit 104 extracts, when image data which is indicated from a terminal of a first user among the plurality of users is inputted, a user having image data which is similar to the inputted image data in the user information 112 as a registration user candidate who is a candidate of a user registered as a communication target by the first user, from the plurality of users, and outputs the extracted user to the terminal of the first user.

According to the first exemplary embodiment of the present invention, in the service providing system which provides communication among a plurality of users, an acquaintance can be registered as a friend that is the communication target user without using text-based information related to the acquaintance. The reason is because the user extraction unit 104 extracts a user whose image data is similar to image data inputted from a requesting user as a friend candidate in the user information 121 and outputs the extracted user.

As a result, even when the requesting user does not know the text-based information such as a name and a mail address of the acquaintance, the requesting user can register the acquaintance as the friend in the service providing system by using a photograph including a face image of the acquaintance, such as a group photograph of a class of school, a photograph with the acquaintances, for example, and perform communication.

### Second Exemplary Embodiment

Next, a second exemplary embodiment of the present invention will be described.

In the second exemplary embodiment of the present invention, the user, of which the degree of similarity is calculated in the process for extracting the friend candidate, is limited to the user having an attribute value that is equal to the attribute value of a predetermined attribute of the requesting user. This is a difference between the first exemplary embodiment and the second exemplary embodiment.

The configuration of the second exemplary embodiment of the present invention is the same as that of the first exemplary embodiment of the present invention.

Next, operation of the service providing apparatus 100 according to the second exemplary embodiment of the present invention will be described.

In the second exemplary embodiment of the present invention, in the process (in FIG. 3, steps S103 to S106) for extracting the friend candidate in the first exemplary embodiment of the present invention, the image processing section 105 calculates the degree of similarity of the user whose attribute value of the predetermined attribute in the user information 121 is equal to the attribute value of the predetermined attribute of the requesting user.

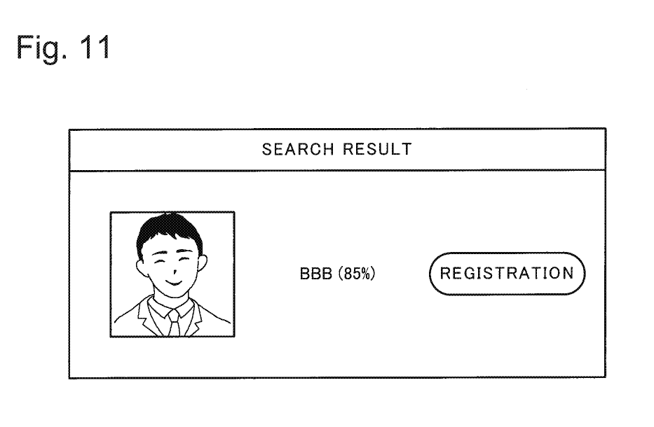

FIG. 10 is an example of the friend candidate list 122 according to the second exemplary embodiment of the present invention. FIG. 11 is a figure showing an example of a user interface for friend candidate output according to the second exemplary embodiment of the present invention.

For example, it is assumed that the company name is used as the predetermined attribute, the user who belongs to the same company as the requesting user is found by referring to the “company name” column in the user information 121 shown in FIG. 4, and the degree of similarity of the user is calculated. Here, when the requesting user is the user having the user identifier of “0004”, it is found in the user information 121 shown in FIG. 4 that the requesting user belongs to the company whose name is “EFG Corp.” and the user having the user identifier of “0002” belongs to the same company. Accordingly, the image processing section 105 calculates the degree of similarity of the user having the user identifier of “0002”.

The image processing section 105 generates the friend candidate list 122 in which the user identifier of “0002” is set as shown in FIG. 10. The image processing section 105 generates the user interface as shown in FIG. 11 and transmits the generated user interface to the user terminal 500 of the requesting user.

Further, for example, it is assumed that the friend list is used as the predetermined attribute, the user who has a common friend with the requesting user is found by referring to the “friend list” column in the user information 121 shown in FIG. 4, and the degree of similarity of the user is calculated. Here, when the user having the user identifier of “0004” is the requesting user, it is found in the user information 121 shown in FIG. 4 that the user having the user identifier of “0004” that is the requesting user has the common friend having the user identifier of “0033” with the user having the user identifier of “0002”. Accordingly, the image processing section 105 calculates the degree of similarity of the user having the user identifier of “0002”.

Further, the image processing section 105 may calculate the degree of similarity as follows. When it is found in the user information 121 shown in FIG. 4 that the user has a predetermined number or more common friends with the requesting user, the image processing section 105 calculates the degree of similarity of the user.

With that, the operation according to the second exemplary embodiment of the present invention is completed.

According to the second exemplary embodiment of the present invention, when a large number of users exist, the load of the process of the friend registration can be reduced. The reason is because the image processing section 105 of the user extraction unit 104 calculates a degree of similarity of a user whose attribute value of a predetermined attribute in the user information 121 is equal to an attribute value of the predetermined attribute of the requesting user.

Further, according to the second exemplary embodiment of the present invention, information about a person who is not related to the requesting user can be prevented from being acquired by the requesting user by using the image data of a person not related to the requesting user. The reason is because, by specifying a group to which the requesting user belongs such as a company name, a school name as the above-mentioned predetermined attribute, the user for which the degree of similarity is calculated can be limited to a user who belongs to the group to which the requesting user belongs. Further, another reason is because, by designating, for example, the friend list as the above-mentioned predetermined attribute, the user for which the degree of similarity is calculated can be limited to a user who has the common friend with the requesting user.

### Third Exemplary Embodiment

Next, a third exemplary embodiment of the present invention will be described.

In the third exemplary embodiment of the present invention, when the face image of the requesting user is included in the image data inputted from the requesting user, the friend candidate is extracted. This is a difference between the third exemplary embodiment and the first exemplary embodiment of the present invention.

The configuration of the third exemplary embodiment of the present invention is the same as that of the first exemplary embodiment of the present invention.

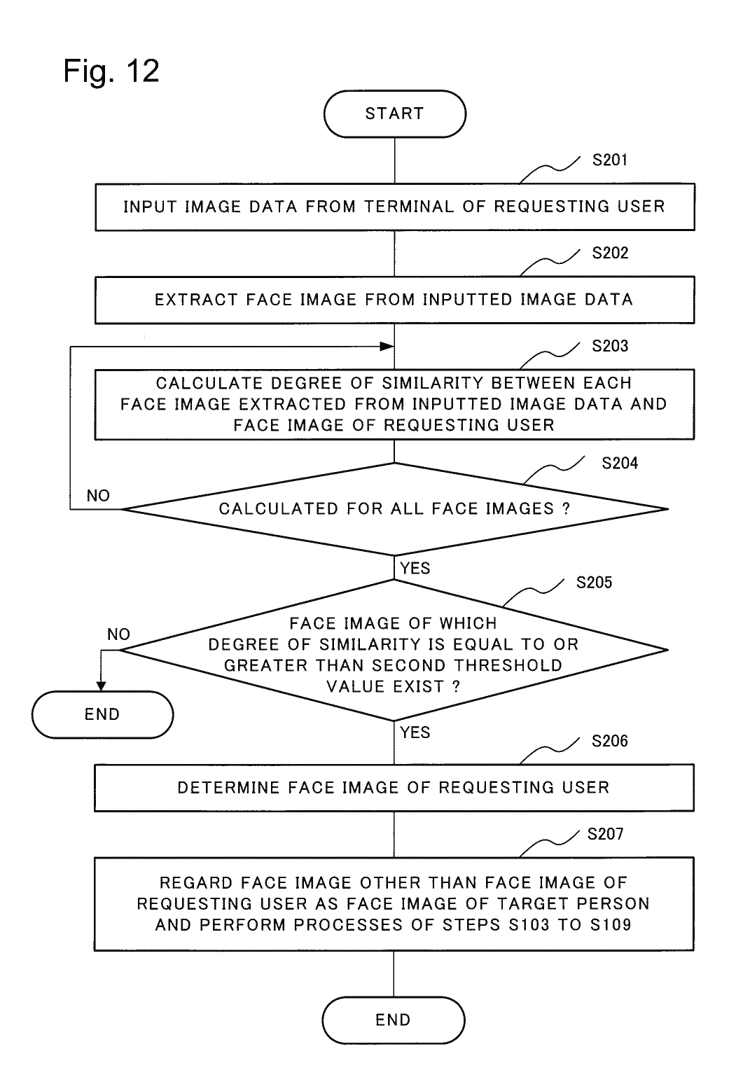

Next, the operation of the service providing apparatus 100 according to the third exemplary embodiment of the present invention will be described. FIG. 12 is a flowchart showing a process of the service providing apparatus 100 according to the third exemplary embodiment of the present invention.

First, the user extraction unit 104 of the service providing apparatus 100 receives input of image data including face image of the target person (acquaintance) from the user terminal 500 of the requesting user (step S201).

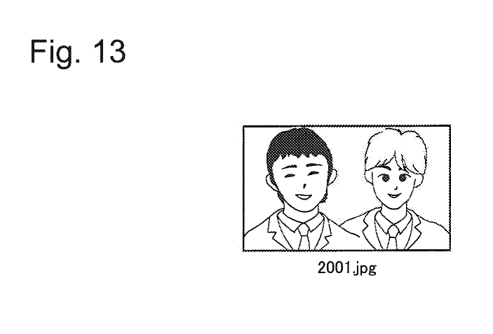

FIG. 13 is a figure showing an example of the image data inputted from the requesting user in the third exemplary embodiment of the present invention. Here, the face image of the user having the user identifier of “0002” that is the target person and the face image of the user having the user identifier of “0004” that is the requesting user are included in the image data shown in FIG. 13.

For example, the user extraction unit 104 receives the input of the image data shown in FIG. 13 from the user terminal 500 of the user having the user identifier of “0004”.

Next, the image processing section 105 of the user extraction unit 104 extracts all pieces of the face image data from the image data inputted in step S201 by using the face recognition section 106 (step S202).

The image processing section 105 calculates the degree of similarity between each piece of the face image data extracted in step S102 and the face image data included in the profile image of the requesting user in the user information 121 (step S203). The image processing section 105 repeats the process of step S203 for all pieces of the face image data extracted in step S202 (step S204).

The image processing section 105 determines whether or not the face image data of which the value of the degree of similarity calculated in step S204 is equal to or greater than a predetermined threshold value (a second threshold value) exists (step S205). When the face image data of which the value of the degree of similarity is equal to or greater than the predetermined threshold value (the second threshold value) exists (step S205/Yes), it is determined by the image processing section 105 that the face image data is the face image data of the requesting user (step S206). The image processing section 105 regards each piece of the face image data other than the piece of the face image data of the requesting user among the pieces of the face image data extracted in step S202 as the face image data of the target person and performs the extraction process of the friend candidate and the friend registration process in the first exemplary embodiment of the present invention (steps S103 to S109 in FIG. 3) (step S207).

On the other hand, in step S205, when the face image data of which the value of the degree of similarity is equal to or greater than the predetermined threshold value (the second threshold value) does not exist (step S205/No), the image processing section 105 ends the process.

With that, the operation according to the third exemplary embodiment of the present invention is completed.

According to the third exemplary embodiment of the present invention, information about a person who is not related to the requesting user can be prevented from being acquired by the requesting user by using the image data of the person not related to the requesting user. The reason is because the image processing section 105 of the user extraction unit 104 extracts the friend candidate when one of the plurality of pieces of face image data included in the image data inputted from the requesting user is similar to the face image data of the requesting user in the user information 121.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, in the exemplary embodiment of the present invention, the user extraction unit 104 outputs, as the friend candidate, the user having a profile image including the face image similar to the face image extracted from the image data inputted from the requesting user, in the plurality of users. However, the target that is extracted from the image data and used for the determination of similarity by the user extraction unit 104 is not limited to the face image. The user extraction unit 104 may determine whether or not an arbitrary part included in the image data such as a part other than the face of the person, the clothes, the personal belongings or the background in the image data inputted from the requesting user is similar to that of the profile image, if it represents the feature of the target person.

In the first exemplary embodiment of the present invention, the image processing section 105 repeats the processes (steps S103 to S105) for extracting the friend candidate for all the users other than the requesting user. However, these processes may end when a predetermined condition is satisfied. For example, the image processing section 105 may end the repeating process when the number of friend candidates reaches a predetermined value. As a result, when a large number of users exist, the load of the process for extracting the friend candidate can be reduced.

Further, the image processing section 105 may output the friend candidate when adding the friend candidate in the friend candidate list 122 (step S105). As a result, even when a large number of users exist, before the calculation of the degree of similarity for all the users and the determination end, the friend candidate list 122 can be successively outputted.

Further, in the second exemplary embodiment of the present invention, the image processing section 105 performs the process for extracting the friend candidate to the user whose attribute value of the predetermined attribute in the user information 121 is equal to the attribute value of the predetermined attribute of the requesting user. However, the image processing section 105 may perform the process for extracting the friend candidate to a user whose attribute value of the predetermined attribute in the user information 121 is equal to a predetermined value designated by the requesting user or the like in advance. As a result, when a large number of users exist, the load of the process for extracting the friend candidate can be reduced like the second exemplary embodiment of the present invention.

This application is based upon and claims the benefit of priority from Japanese Patent Application No. 2011-151589, filed on Jul. 8, 2011, the disclosure of which is incorporated herein in its entirety by reference.

### REFERENCE SIGNS LIST

1 service providing system

100 service providing apparatus

101 input-output unit

102 authentication unit

103 service providing unit

104 user extraction unit

105 image processing section

106 face recognition section

107 user relation management unit

111 user information storage unit

121 user information

122 friend candidate list

500 user terminal

600 network

What is claimed is:

1. A service providing apparatus comprising:
a user information storage unit which stores user information which includes image data of each of a plurality of users; and
a user extraction unit which extracts, when image data which is indicated from a terminal of a first user among the plurality of users is inputted, a user having image data which is similar to the inputted image data in the user information as a registration user candidate who is a candidate of a user registered as a communication target by the first user, from the plurality of users, and outputs the extracted user to the terminal of the first user.

2. The service providing apparatus according to claim 1, wherein
the user information includes an attribute of each of the plurality of users, and
the user extraction unit extracts the registration user candidate from users having a value of the attribute which is equal to a predetermined value, among the plurality of users.

3. The service providing apparatus according to claim 2, wherein
the user extraction unit extract the registration user candidate from users having a value of the attribute which is equal to a value of the attribute of the first user, among the plurality of users.

4. The service providing apparatus according to claim 3, wherein
the attribute indicates, for each of the plurality of users, a registered user that is a user registered as the communication target and other than the user, and
the user extraction unit extracts the registration user candidate from users having a registered user that is the same as a registered user of the first user, among the plurality of users.

5. The service providing apparatus according to claim 1, wherein
the image data of each of the plurality of users includes a face image of the user, and
the user extraction unit extracts face image data from the inputted image data, and extracts a user having image data, in the user information, including face image data similar to the extracted face image data in the user information as the registration user candidate, among the plurality of users.

6. The service providing apparatus according to claim 5, wherein
the user extraction unit extracts a plurality of pieces of face image data from the inputted image data, and outputs the registration user candidate when one of the extracted plurality of pieces of face image data is similar to the face image data included in the image data of the first user in the user information.

7. A service providing method comprising:
storing user information which includes image data of each of a plurality of users; and
extracting, when image data which is indicated from a terminal of a first user among the plurality of users is inputted, a user having image data which is similar to the inputted image data in the user information as a registration user candidate who is a candidate of a user registered as a communication target by the first user, from the plurality of users, and outputting the extracted user to the terminal of the first user.

8. The service providing method according to claim 7, wherein
the user information includes an attribute of each of the plurality of users, and
the extracting extracts the registration user candidate from users having a value of the attribute which is equal to a predetermined value, among the plurality of users.

9. A non-transitory computer readable storage medium recording thereon a program, causing a computer to perform a method comprising:
storing user information which includes image data of each of a plurality of users; and
extracting, when image data which is indicated from a terminal of a first user among the plurality of users is inputted, a user having image data which is similar to the inputted image data in the user information as a registration user candidate who is a candidate of a user registered as a communication target by the first user, from the plurality of users, and outputting the extracted user to the terminal of the first user.

10. The non-transitory computer readable storage medium according to claim 9, recording thereon the program causing the computer to perform the method, wherein
the user information includes an attribute of each of the plurality of users, and
the extracting extracts the registration user candidate from users having a value of the attribute which is equal to a predetermined value, among the plurality of users.

11. A service providing apparatus comprising:
a user information storage means for storing user information which includes image data of each of a plurality of users; and
a user extraction means for extracting, when image data which is indicated from a terminal of a first user among the plurality of users is inputted, a user having image data which is similar to the inputted image data in the user information as a registration user candidate who is a candidate of a user registered as a communication target by the first user, from the plurality of users, and outputting the extracted user to the terminal of the first user.
